(19) United States
(12) Patent Application Publication
(10) Pub. No.: US 2008/0294278 A1
(43) Pub. Date: Nov. 27, 2008

(54) Determining Viewing Distance Information for an Image

(76) Inventors: Blake Charles Borgeson, Austin, TX (US); Orion Seth Jensen, Cedar Park, TX (US)

Correspondence Address: Jeffrey C. Hood;Meyertons Hood Kivlin Kowert & Goetzel PC, P.O. Box 398, Austin, TX, 78767-0398, US

(21) Appl. No.: 11/752,768

(22) Filed: May 23, 2007

(51) Int. Cl. G06F 19/00; G06F 3/00; G06F 3/01

(52) U.S. Cl. 700/97; 715/700

(57) ABSTRACT

A method for enabling a user to interactively design a sign to be manufactured. The method may provide viewing distance information to a user during the design process, thus allowing the user to more intelligently specify various criteria for the sign, such as sign size, image/text size, etc. Alternatively, the user may specify viewing distance information, and the method may automatically determine the appropriate sign size and/or image/text size based on the viewing distance information.

### FIELD OF THE INVENTION

The present invention relates to the field of image analysis and more particularly to a system and method for determining viewing distance information for an image.

### DESCRIPTION OF THE RELATED ART

Various computer software tools currently exist which allow a user to interactively design a sign to be manufactured. Many of these tools involve the user providing a desired image and/or text to be used on the sign and then specifying various characteristics of the sign on a graphical user interface. For example, the user may provide input regarding the size of the sign, the size of the image/text on the sign, etc. These tools generally display the sign being designed on a display, and the user provides input to place and size the image/text on the sign. However, often it is difficult for the user to specify the appropriate size of the sign as well as the size of the image/text appearing on the sign. More specifically, it is often difficult for the user to properly assess how the completed sign will appear to viewers, given that the completed sign will typically be a different size than that shown on the computer display, and the viewing distance of viewers relative to the sign often varies considerably for different types of signs. Therefore, improved computer software tools are desired which enable a user to interactively design a sign.

### SUMMARY OF THE INVENTION

Various embodiments of the invention relate to a system and method for enabling a user to interactively design a sign to be manufactured. The method may provide viewing distance information to a user during the design process, thus allowing the user to more intelligently specify various criteria for the sign, such as sign size, image/text size, etc. In another embodiment, the user may specify viewing distance information, and the method may automatically determine the appropriate sign size and/or image/text size based on the viewing distance information.

The system may comprise a server computer system that executes software which enables a user to interactive specify the sign to be created. The server may be a web server connect to a wide area network, such as the Internet, and may present a website for creation of the sign. A user operating a client computer system may connect to the server over the Internet and interact with the website to specify the sign. In another embodiment, the method may operate on a local computer system operated by a user, and may not be an Internet-based tool.

In a first embodiment, the user provides an image that the user desires to appear on the sign. The method may perform one or more image enhancement operations to improve the image quality properties of the image, and/or may convert at least a portion of the image to a vector format. The method then analyzes the image to determine image quality properties of the image. For example, the method may analyze various characteristics of the image, such as the image resolution, or other image quality characteristics.

The user may then specify a size of the sign to be created, i.e., the physical dimensions of the sign. The user may also specify a printing size of the image that will appear on the sign, i.e., a size of the image when the image actually appears on the (to be) manufactured sign. For example, the user may select a size for the sign, e.g., by selecting a desired sign size or by resizing a template image of a sign on the display. The method may then display a representation of the sign being created on a display including the user supplied image. The representation of the sign may comprise a representation of the image at an initial or default printing size (referred to as the initial printing size) relative to the size of the sign. For example, the method may automatically determine the initial printing size of the image based on the size of the sign and the image quality properties of the image. The initial printing size may be automatically determined based on a predetermined viewing distance metric. The user may then provide input specifying a desired printing size of the image, e.g., by adjusting the initial printing size of the image on the display to a different size.

The method then determines viewing distance information of the image when the image is presented at the selected printing size. The viewing distance information may comprise a minimum viewing distance, a maximum viewing distance, and/or an optimum viewing distance. The viewing distance information is determined based on the image quality properties of the image and the printing size of the image. The viewing distance information may also be determined utilizing a predetermined viewing distance metric, e.g., a product of viewing distance and image quality. For example, in one embodiment the predetermined metric comprises a product of approximately 3.5 feet and approximately 100 dots per inch (DPI), although other metrics may of course be used.

The viewing distance information is displayed to the user, and the user can use the viewing distance information to interactively adjust various characteristics of the image/sign, such as sign size, image size, text size, etc. For example, the viewing distance information provided to the user may indicate that the image size is too small or too large, and thus the user can adjust the image size accordingly until the desired viewing distance is achieved. For example, the method may display a warning if the viewing distance information indicates that the printing size will produce a sub-optimal sign. The method may operate in an iterative manner, whereby the user specifies a printing size of the image, the method determines and displays viewing distance information, and the user adjusts the sign characteristics accordingly. In one embodiment, the method may suggest a different sign size based on the determined viewing distance information.

After the user has finished specifying the characteristics of the sign, the user may select an option to have the sign created according to the specified characteristics, i.e., with the specified sign size, the printing size of the image, etc. The created sign may then be provided, e.g., mailed, to the user.

In another embodiment, the method may comprise receiving an image (e.g., over a network) and receiving user input specifying a size of a sign to be created. The method also analyzes the image as described above to determine image quality properties of the image. The user may then specify a viewing distance, or a range of viewing distances, for the sign comprising the image. For example, if the sign is a large billboard, the user may specify a viewing distance of between 75-100 feet. In contrast, if the sign is a small political sign designed to be displayed in a person's front yard, the user may specify a viewing distance of 20 feet or so.

The method then automatically determines a printing size of the image based on the size of the sign, the image quality properties of the image, and the viewing distance metric. As noted above, the printing size of the image refers to the size of the image that will appear on the (to be) completed sign. The user may select an option to perform this automatic determination. Thus, the method in this embodiment automatically determines the printing size of the image based on various factors. The method may also determine and suggest a different sign size to the user based on these parameters.

Once the printing size has been determined, the method may display a representation of the sign on a display that comprises a representation of the image at the printing size relative to the size of the sign. The user can then choose to resize the image, change the sign size, etc. If the user chooses to change one or more parameters, such as the sign size, viewing distance, etc., the user can reselect the option to automatically determine the printing size of the image. When the user is completed, the user may select an option to cause creation of the sign, which may then be delivered to the user.

In another embodiment, the user specifies the viewing distance, or a range of viewing distances, for the sign, and the method automatically determines both the size of the sign and the printing size of the image based on the image quality properties of the image, the viewing distance for the sign, and an viewing distance metric.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system according to an embodiment of the present invention;

FIG. 1B illustrates a network system comprising two or more computer systems configured to implement some embodiments of the present invention;

FIG. 2 is a flowchart diagram illustrating an embodiment of a method for determining viewing distance information for an image;

FIG. 3 is a flowchart diagram illustrating an embodiment of a method for specifying viewing distance information for an image;

FIG. 4 is a flowchart diagram illustrating an embodiment of a method for determining viewing distance information for a sign.

FIG. 5 is a flowchart diagram illustrating an embodiment of a method for designing a sign; and

FIGS. 6-13 are exemplary screen shots illustrating an exemplary walk through according to a specific embodiment of the methods described herein.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C#, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner.

Graphical User Interface—this term is intended to have the full breadth of its ordinary meaning. The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

Graphical User Interface Element—an element of a graphical user interface, such as for providing input or displaying output. Exemplary graphical user interface elements comprise input controls and output indicators.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Sign—the term “sign” is intended to have the full breadth of its ordinary meaning in the context of a physical medium which displays static text and/or images. The physical medium may be a stiff medium (e.g., cardboard, plastic, wood, or metal), a flexible medium (e.g., paper), an adhesive medium (e.g., stickers or magnetics), and/or other type of physical medium. Generally, signs may be larger than a typical display screen. Additionally, the text and/or images may convey a message or meaning to a customer or person. For example, a sign may include advertisement information for attracting potential customers (e.g., billboards), personal opinion(s) (e.g., in a bumper sticker), political information (e.g., advocating a particular politician), child information (e.g., identifying achievements and/or memberships of children), and/or other information. Examples include billboards, yard signs, bumper stickers, window signs, banners, magnetics, real estate signs, parking signs, street signs, license plates, etc.

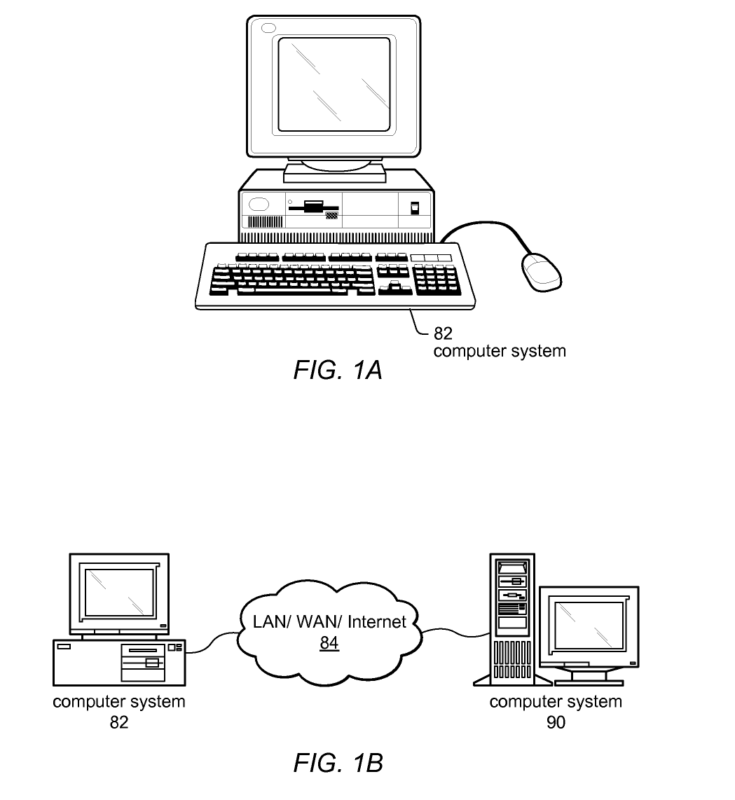

### FIG. 1A—Computer System

FIG. 1A illustrates a computer system 82 operable to perform various embodiments described herein. The computer system 82 may include at least one memory medium on which one or more computer programs or software components according to one embodiment of the present invention may be stored. For example, the memory medium may store one or more programs which are executable to perform the methods described herein. The memory medium may also store operating system software, as well as other software for operation of the computer system. Various embodiments further include receiving or storing instructions and/or data implemented in accordance with the foregoing description upon a carrier medium.

As shown in FIG. 1A, the computer system 82 may include a display device operable to display a graphical user interface (GUI) of the one or more programs stored/executed by the computer system. For example, the computer system may execute a web browser and display various web pages (such as those described herein) on the display device.

### FIG. 1B—Computer Network

FIG. 1B illustrates a network system comprising two or more computer systems configured to implement some embodiments of the present invention. As shown, the system includes a first computer system 82 that is coupled to a second computer system 90. The computer system 82 may be coupled via a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute a program or web application in a distributed fashion. For example, computer 82 may execute a first portion of the web application and computer system 90 may execute a second portion of the web application. As another example, computer 82 may display a web page stored on the computer system 90. In this example, the computer system 90 may store and execute web server software to present a website that the client computer 82 may access, e.g., over the Internet. Thus, in various embodiments, the computer system 82 may be a client computer system and the computer system 90 may be a server computer system which provides content or applications to the computer system 82.

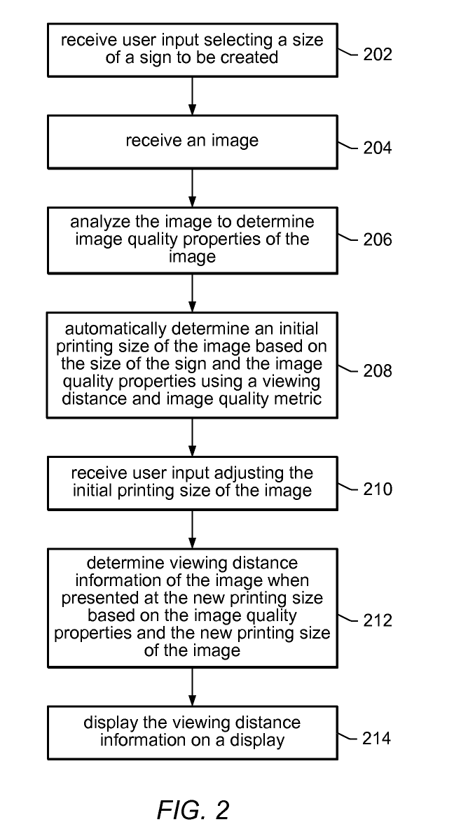

### FIG. 2—Method for Determining Viewing Distance Information for an Image

FIG. 2 illustrates a method for determining viewing distance information for an image. The method shown in FIG. 2 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 202, user input may be received specifying a size of a sign to be created. In some embodiments, the user input may be received over network 84, such as the Internet (e.g., between the computer system 82 and the computer system 90). In other words, the user input may be provided to the client computer system 82, wherein the client 82 provides the input over the network 84 to the server system 90. Alternatively, the user may provide the input to a program executing on a computer system, e.g., the computer system 82. For example, in this embodiment, the computer system 82 may be provided at a sign design store where customers design the sign and the signs may correspondingly be created.

In one embodiment, the user may select a sign size from a list of available sizes. Alternatively, the user may be able to specify a custom size, e.g., by providing the dimensions of the desired sign. For example, the user may numerically specify the dimensions. Alternatively the user may be provided with a sign “template” that the user can resize using a mouse. In this embodiment, as the user resizes the sign on the template, numerical dimension information may be updated accordingly. For example, the user may select a desired template sign, and the sign may have a predetermined size (or possibly a default size). The user may then have the opportunity to change the sign size if desired, e.g., by selecting or specifying dimensions for the sign. Thus, the user may specify the size of the sign using a variety of methods.

In 204, an image may be received. In various embodiments, the image may be received over a network, e.g., the Internet (among other networks, such as those described above). For example, the image may be initially stored on the computer system 82, and the user may operate the computer system 82 to provide the image to the computer system 90 over the network. Alternatively, as indicated above, the image may be received to a computer system locally (which may be executing software locally). For example, the user may manipulate an image that is already stored on a local machine (e.g., the computer system 82) and/or stored on the server system of the website (e.g., the computer system 90). Thus, in step 204 the user may select an image on the server 90, wherein user selection of this image already present on the server 90 (or another server) causes the image to be “received” by the server 90.

In 206, the image may be analyzed to determine image quality properties of the image. The image analysis may be performed by a program being executed locally (e.g., on the computer system 82), remotely (e.g., on the computer system 90), or using some combination thereof. For example, in one embodiment, the computer system 90 may provide a web application (e.g., a web app or web applet) to the computer system 82, and the computer system 82 may execute the web application to perform the analysis.

Image quality properties may include simple characteristics such as resolution, number of pixels, and/or size/dimensions of the image, among others. In one embodiment, image quality properties may include DPI of the image, e.g., where the image specifies a size for printing or displaying. Thus, in one embodiment, simple properties or characteristics of the image may be used to determine the image quality properties of the image. However, these simple measurements may not accurately test for the image quality of the image. For example, a small image that has been blown up may now have a high resolution, number of pixels, resolution, etc., but may still have inherent poor quality. To measure this type of image quality, other properties may be determined. For example, error (e.g., mean-squared error), signal-to-noise ratio (e.g., peak signal-to-noise ratio), pixelation, blurriness, jaggedness, contrast, color, and/or other information may be determined.

Additionally, determining the image quality properties may include object or text recognition in the image. Correspondingly, one or more calculations or analyses may be performed on the recognized object or text to determine the quality thereof. More specifically, pixelation, jaggedness, blurriness, mean-squared error, signal-to-noise (e.g., peak signal-to-noise ratio), and/or other information related to the recognized object or text may be used to determine the image quality properties. For example, the text in the image may be analyzed for readability. Thus, image quality characteristics may be determined for the image as a whole as well as portions of the image (e.g., the objects or text in the image). In one embodiment, the method in 206 selects a default portion of an image for analysis, in order to reduce the amount of processing time required to analyze an entire image.

In some embodiments, analysis of the image may include determining whether the image (or portions thereof) are vector images (or formatted in a vector format). Vector formatted images are images which are generated or viewed according to formulas instead of the specification of individual pixels (as is the case for normal raster images). Thus, vector formatted images may be resized losslessly (without transformation loss).

In 208, an initial printing size of the image may be automatically determined based on the size of the sign and the image quality properties. In one embodiment, the initial printing size may also be determined using a viewing distance metric. In some embodiments, the viewing distance metric may use viewing distances, image qualities, qualities of the image when printed (e.g., DPI of the printed image), and/or other information. For example, in one embodiment, the metric may be a product of a specific DPI and distance. For example, the metric may be approximately 350 DPI*ft. According to various embodiments, for this particular case, approximately may mean varying by 1, 2, 5, or 10 percent from 350 DPI*ft. Additionally, note that other units and values (e.g., converted from or approximate to 350 DPI*ft) are envisioned. Thus, determining an initial printing size using this particular metric, may include calculating the initial printing size using the image quality properties and the size of the sign. As one example, the initial printing size of the image may be calculated using the metric and a value for a minimum viewing distance (described in more detail below). An exemplary minimum viewing distance may be approximately 3.5 feet. In this case, approximately may mean varying according to the percentages described above, or, according to various embodiments, varying between 3.4 and 3.6 feet, 3.3 and 3.7 feet, 3.2 and 3.8 feet, 3.1 and 3.9 feet, and 3 and 4 feet. Using 3.5 feet as the value, each component of the printing dimension (horizontal and vertical) may be calculated according to the following formula:

Printing Size(inches)=(Dimension of Image(pixels)*3.5(feet))/350(DPI*feet), or in more simplified form:

Printing Size(inches)=Dimension of Image(pixels)/100(DPI)

Note that these formulas are derived from the formula for DPI which is discussed in more detail below. Thus, the initial printing size of the image may be calculated (e.g., by calculating the initial printing size of each dimension of the image). Note that the above formulas, calculations, and units are exemplary only and that others are envisioned.

Additionally, where the image is a vector image, a default printing size may be used. In some embodiments, the default printing size may be a static value or may be calculated based on the size of the sign. Where the image includes both raster and vector portions, the calculations such as those described above may be performed based on the initial size of the image or based on the raster portions of the image.

After determining the initial printing size of the image, the method may further include displaying a representation of the sign on a display. The representation of the sign may include a representation of the image at the printing size relative to the size of the sign. For example, an image of the sign may be displayed on the display (e.g., of the computer system 82) and the image of the sign may be properly scaled relative to the size of the sign. In other words, the image specified by the user may be displayed to scale in the image of the sign. In preferred embodiments, the image of the sign may be displayed in a web browser executing on the computer system 82. The image of the sign may be provided from a web site (e.g., provided by the computer system 90) or may be provided from the computer system 82 (e.g., a program executing on the computer system 82). Thus, the representation or scaled image of the sign may be presented to the user locally or remotely, as desired.

In 210, user input may be received adjusting the initial printing size of the image. In primary embodiments, the user input may be received by manipulating the representation of the sign on the computer display. For example, the user may resize the representation of the image on the representation of the sign, thereby changing the printing size of the image. As a more specific example, the user may see a picture of the sign which includes the image on the display, and the user may be able to modify the size of the image on the picture of the sign directly. In one embodiment, the user may use a mouse to select the image and drag the borders (or corners) of the image to interactively change the printing size of the image on the display. Correspondingly, while receiving the input, the computer system may update the display so that the image is displayed according to the user input, thereby allowing the user to see the change occur while it happens. Note that in preferred embodiments, the user may be able to perform other operations other than adjusting the printing size using the representation of the sign. For example, the user may move the location of the image on the sign (to be printed or created), edit the image, add text, change the sign size and/or perform other operations.

In one embodiment, the user input in 210 may include specification of a desired printing size of the image. For example, the user may simply enter desired dimensions of the printing size of the image on the sign. In one embodiment, the user may enter both horizontal and vertical dimensions for the image. Alternatively, the user may provide a single dimension and the corresponding dimension may be calculated using the aspect ratio of the image. Note that the above-described methods for adjusting the printing size are exemplary only and that other methods are envisioned.

In 212, viewing distance information of the image when presented at the new printing size may be determined based on the image quality properties and the new printing size of the image. In other words, the viewing distance information may indicate distance information of the image when it is printed on the sign.

In one embodiment, the viewing distance information may include a minimum viewing distance. For example, the minimum viewing distance may be calculated using a predetermined viewing distance metric, such as the viewing distance metric described above in 208. As one particular example, the viewing distance metric may include a value which indicates a desirable relationship between the image quality and the minimum viewing distance of the image on the sign to be created. The value may be approximately equal to 350 DPI*ft, as described above. Thus, using this particular metric, calculating the minimum viewing distance may include calculating the DPI using image quality properties and the printing size of the image.

More specifically, the DPI may be calculated by first determining the DPI of each dimension. For example, the horizontal DPI (DPIx) may be calculated according to the following formula:

DPIx=(Original Image Width*Display Canvas Width)/(Printing Width*Sign Width),

where the Original Image Width=the pixel width of the image, the Display Canvas Width=the pixel width of the representation of the image, Printing Width=the pixel width of the image when printed, and the Sign Width=the physical width (in inches) of the sign.

Alternatively, the DPI may be calculated by dividing the original image width (in pixels) with the printing width (in inches) of the image on the sign. The DPIy (the vertical DPI) may similarly be calculated.

Correspondingly, the DPI may be used to calculate the minimum viewing distance. For example, the minimum viewing distance may be calculated according to the following formula:

Minimum Viewing Distance=Quality Constant/Minimum(DPIx,DPIy)

In this case, the quality constant may be the metric described above. For example, the quality constant may be 350 DPI*ft. Thus, for an image with an original dimensions of 640×500 pixels which is printed with printing dimensions of 2 feet by 1.5 feet, the minimum viewing distance may be calculated by dividing 350 DPI*ft (or a similar number) by 320 (in this case, the minimum DPI is DPIx). Thus, the minimum viewing distance for this specific example may be 1.1 feet. Note that the above described examples, formulas, and constants are exemplary only and that others are envisioned.

Alternatively, or additionally, the viewing distance information may include maximum viewing distance. In some embodiments, this information may be calculated using various metrics, e.g., distance and/or image quality metrics. For example, in one embodiment, the maximum viewing distance may be based on readability of text on the sign or in the image (as detected during image analysis) and/or the recognizability of the objects in the image. For example, if the image includes the text “Advertisement”, the maximum viewing distance may indicate the maximum distance an average user could easily read the word (or understand the meaning of the text). Alternatively, or additionally, the maximum viewing distance may relate to the recognizability of objects in the image. For example, if the image includes a tiger, the maximum viewing distance may be the distance an average user could easily recognize the tiger. In some embodiments, the maximum viewing distance may relate to how easily an average user understands the image or meaning of the image/sign.

In one embodiment, the viewing distance information may include optimum viewing distance information. In some embodiments, the optimum viewing distance may be a range of values which are bounded by the minimum and maximum viewing distances. For example, the range may be the bounds themselves or some values within the bounds, e.g., based on a weighted average or curve. For example the optimum viewing distance may be centered on the average of the minimum and maximum and may only include a percentage of the entire range. As one example, the optimum viewing distance may be 80% of the range, centered on the average. For example, where the minimum viewing distance is 2′ and the maximum viewing distance is 12′, the optimum viewing distance may be 3′-11′. Other percentages could be used as desired, e.g., 50%, 25%, 75%, etc. Additionally, the optimum viewing distance may be skewed towards the minimum or maximum viewing distance. In one embodiment, the optimum viewing distance may include the minimum viewing distance, but may not include the maximum distance. For example, the optimum viewing distance may exclude a percentage or a static value from the end of the range. Following the minimum and maximum example above and assuming 80%, the optimum viewing distance may be 2′-10′. Note that these ranges and calculations are exemplary only.

Alternatively, the optimum viewing distance may be a single distance within the bounds of the minimum and maximum viewing distances. Similar to above, the optimum viewing distance may be a simple average, a weighted average, or any other type of calculation, as desired. Thus, the viewing distance information may include optimum viewing distance, which may be calculated using various different methods.

In 214, the viewing distance information may be displayed. The viewing distance information may be displayed in a web browser (e.g., in a web applet being executed by the computer) and/or in a GUI of a program executing on the computer system 82, among others. As indicated above, the program/web application may be executing on the computer system 82 and/or the computer system 90, as desired. Alternatively, or additionally, the viewing distance information may be displayed graphically, e.g., in the program or web browser executing on the computer system 82.

For example, the GUI or web page may include an image which depicts the sign (sign icon) and a person (person icon) viewing the sign. As the viewing distance changes (e.g., after repeated adjustment of the image printing size), the distance between the depicted person and the sign may correspondingly change. In some embodiments, the depiction may include dimensions indicating the distance between the user and sign or dimensions of the sign itself. Alternatively, or additionally, the depiction may include a key which indicates a scale. In one embodiment, the user may interactively adjust the position of either the person icon or sign icon to change the viewing distance, and hence change the size of the sign/printed image on the sign. In this embodiment, the sign (including the printed image) may be also displayed and may be updated accordingly as the user adjusts the sign/person icons on the display.

The method may include displaying a warning if the viewing distance information indicates that the printing size will produce a sub-optimal sign. In one embodiment, a warning may be displayed if the minimum viewing distance exceeds a threshold value. For example, using the metric described above, the image on the sign may not have “high quality” if the minimum viewing distance is calculated to be greater than 3.5 feet. While this may not be an issue for users who want the sign to be viewable (or look good) from a distance greater than 3.5 feet, the printed image quality may look poor. Other threshold values may be used for different viewing distance metrics. Thus, the warning may allow the user to easily understand when an image is being stretched or expanded to a size that may not be desirable.

Alternatively, or additionally, one or more image enhancement operations may be performed on the image to improve the quality and/or the minimum viewing distance of the image when printed on the sign. For example, one or more interpolation procedures may be performed to determine pixels, e.g., during an expansion or resizing of the image to the printing size. Additionally, or alternatively, where text detection is performed during analysis of the image, the one or more enhancement operations may include improving the quality of the individual characters of the text. In some embodiments, the one or more enhancement operations may also include performing anti-aliasing. Additionally, one or more of despeckling, deskewing, red-eye removal, contrast adjustment, tint adjustment, etc. may be performed on the image.

In one embodiment, at least a portion of the image may be converted to a vector format. As described above, vector formatted images may be transformed losslessly (without transformation loss), thereby removing the resizing issue for the image. Thus, to overcome a specific minimum distance, the image (or at least a portion thereof) may be converted to a vector image and then resized. Note that in some cases the vector image may still have an inherent quality and that minimum viewing distance may scale with the resizing of the vector image. Note further that other image enhancement operations are envisioned. In some embodiments, the one or more image enhancement operations may be performed before determining viewing distance information (212) and displaying the distance information (214) as desired. In these embodiments, the viewing distance information may be determined based on the enhanced image. Alternatively, the image may be converted to a vector image at other points in the process, e.g., when the image is received (204) or when the image is analyzed (206), among others.

In some embodiment, the method may further include suggesting a different sign size based on the viewing distance information. For example, where the image on the sign has been stretched or resized to an undesirable size (e.g., when the warning has been or would be displayed), the application or web page may suggest a different sized sign to the user, e.g., based on the image quality properties of the image and the size of the different sized sign. In one embodiment, ideal dimensions for the sign may be calculated, e.g., using the formulas provided above, and presented to the user as a suggestion. Where only specific sized signs are available, the program or applet may select the nearest possible size. Alternatively, the method may recalculate the viewing distance information for different sizes and provide one or more of those options to the user. Alternatively, or additionally, a suggestion may be presented to the user that the user choose a new sign size. Accordingly, the user may specify a new sign size, e.g., using the method described above in 202.

Additionally, or alternatively, in response to determining that the viewing distance information exceeds a threshold, or that the printed sign may be suboptimal, one or more options may be presented to the user to help optimize the appearance of the image and/or sign. For example, one or more of the image enhancement operations, sign size suggestions, and/or conversion of the image to a vector image may be presented to the user (among other options). Thus, the user may be able to choose from a plurality of options to improve the appearance of the sign. In some embodiments, these options may be presented after exceeding a threshold or determining that the sign may be suboptimal; however, the user may be able to invoke these options (e.g., in a link on the web page) at any time, as desired.

In some embodiments, receiving user input specifying a printing size of the image (210), determining viewing distance information (212), and displaying the viewing distance information (214) may be performed one or more additional times, e.g., in an iterative manner, to fully specify the sign.

Additionally, the method may further include creating a sign which includes the image. As specified by the user, the image may be printed on the sign at the printing size. As indicated above, the sign may be any of various signs, as desired. The sign (or a plurality of the signs) may then be provided to the user, e.g., mailed or otherwise delivered to the user. Thus, FIG. 2 illustrates an exemplary method for determining and displaying viewing distance information for an image.

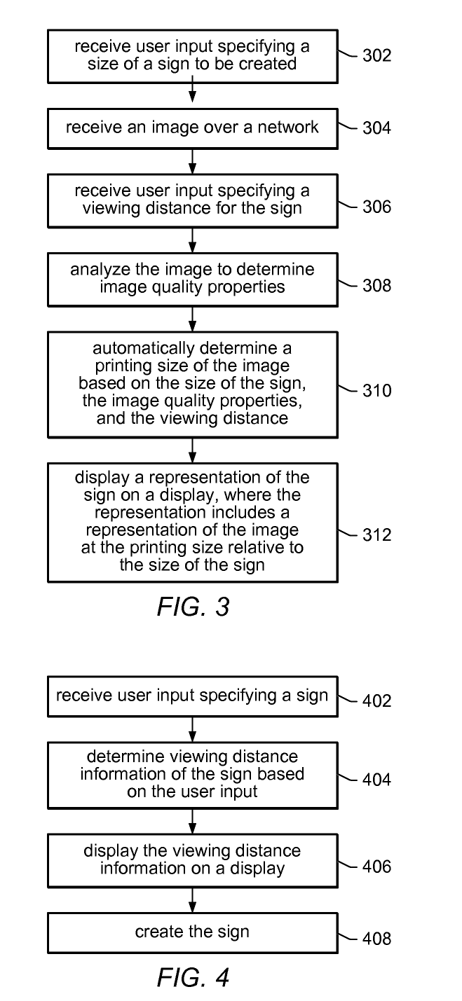

### FIG. 3—Method for Specifying Viewing Distance Information for an Image

FIG. 3 illustrates a method for specifying viewing distance information for an image. The method shown in FIG. 3 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 302, user input specifying a size of a sign may be received. As described above, the size of the sign may be specified explicitly (e.g., by receiving input of the desired dimensions) or implicitly (e.g., by selecting an existing template or sign design). Additionally, the input may be received locally or remotely, as desired.

In 304, an image may be received. Similar to above, the image may be received over a network such as the Internet, or locally, as desired.

In 306, user input specifying a viewing distance for the sign may be received. Similar to descriptions above, the user may specify a minimum viewing distance, a maximum viewing distance, an optimum viewing distance, and/or an optimum viewing distance range, among others. In one embodiment, the user input may be received explicitly, where the user chooses a specific minimum viewing distance (or other type) for the sign. However, the input may be received in other ways, as desired. For example, the user may graphically specify the viewing distance information. In one embodiment, where a graphic of the sign and a person viewing the sign is displayed, the user could drag or move the person viewing the sign to specify the viewing distance information. Note that the above-described methods are exemplary only and that other methods for specifying the viewing distance for the sign may be used.

In 308, the image may be analyzed to determine image quality properties. The analysis of the image may be performed according to the methods described in 206, among others.

In 310, a printing size of the image may be automatically determined based on the size of the sign, the image quality properties, and/or the viewing distance. The automatic determination of the printing size may be performed according to the methods described in 208, except that the specified viewing distance information may be used instead of the exemplary 3.5 feet value described above. Note that other methods may be used in addition to those described above.

Similar to descriptions above, If the printing size exceeds a threshold value or it is determined that the printing size would yield a sub-optimal sign (e.g., one that is hard to see, hard to understand, or illegible, among others), one or more image enhancement operations may be performed on the image. Thus, the one or more image enhancements may be performed based on the viewing distance information and the image quality properties of the image. Additionally, or alternatively, the sign may be resized (or a new size may be suggested) based on the analysis of the image. Further, one or more options may be presented to the user (e.g., including those described above) in order to enhance the quality of the sign. Thus, the operations, sign resizing, and/or one or more options may enable or increase viewability of the sign.

In 312, similar to descriptions above, a representation of the sign may be displayed on a display. The representation of the sign may include a representation of the image displayed on the representation of the sign. In other words, the image may be displayed on the representation of the sign in the scale of the sign and according to the determined printing size of the image.

Similar to above, the method may further include creating the sign after the user has specified the sign.

### FIG. 4—Determining Viewing Distance Information for a Sign

FIG. 4 illustrates a specific method for determining viewing distance information for a sign. The method shown in FIG. 4 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 402, user input specifying a sign may be received. The user input may include specification of a sign size, e.g., using the methods described above, among others. Additionally, the user may select a template sign and customize the template sign. Specification of the sign may include specification of one or more images (e.g., as described above), text, and/or the physical medium of the sign.

In 404, viewing distance information of the sign may be determined based on the user input received in 402. In one embodiment, the viewing distance information may be determined for each of the elements of the sign. For example, the viewing distance information of an image may be determined according to the methods described above, among others. Similar techniques may also apply to text on the sign. For example, one or more calculations may be performed to determine readability of the text to determine, for example, a maximum viewing distance for the sign. Correspondingly, the viewing distance information for each object in the sign may be aggregated to determine overall viewing distance information for the sign.

For example, in one embodiment, the minimum viewing distance may be the highest minimum viewing distance of all of the objects. Similarly, the maximum viewing distance may be the lowest maximum viewing distance of all of the objects. Optimum viewing distances (or ranges thereof) may be calculated according to averages of the viewing distances, the range of the highest minimum viewing distance and the lowest maximum viewing distance. Additionally, any of the calculations on the range to produce optimum viewing distances described above may be applied to the calculated minimum and maximum viewing distance of the sign as a whole.

Alternatively, the sign may be treated as a single image, and the methods described above regarding the viewing distance information may be applied to the sign as a whole. Thus, viewing distance information may be determined for the entirety of the sign.

In 406, the viewing distance information may be displayed on a display, e.g., of the computer system 82. In some embodiments, the viewing distance information of the sign may be displayed in addition to the viewing distance information of each of the components of the sign. In one embodiment, the viewing distance information of the sign may be displayed at all times, and viewing distance information of the individual components may only be displayed when selected. Similar to above, the viewing distance information may be depicted graphically (e.g., using one or more depictions of a viewer, the sign, and/or particular components of the sign). Thus, the viewing distance information may be presented to the user.

In 408, the sign may be created according to the user's specification of the sign. The created sign(s) may then be delivered or otherwise provided to the user.

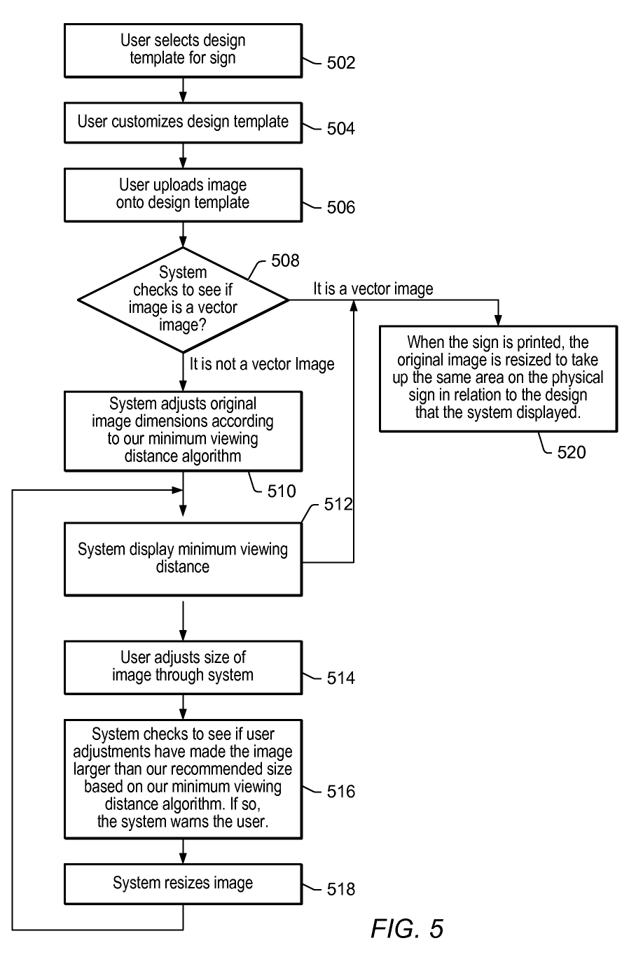

### FIG. 5—Method for Designing a Sign

FIG. 5 illustrates a specific exemplary method for designing a sign. The method shown in FIG. 5 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, the method may operate as follows.

In 502, a user may select a design template for a sign.

In 504, the user may customize the design template.

In 506, the user may upload an image and specify placement of the image on the design template.

In 508, the system may check to see if the image is a vector image.

If the image is a vector image, in 520, the original image may be resized to the printing size.

If the image is not a vector image, in 512, the minimum viewing distance is displayed.

In 514, the user may adjust the size of the image using the system.

In 516, the system may check to see if user adjustments have made the image larger than a recommended size based on a minimum viewing distance algorithm. If so, the system may warn the user.

In 518, the system may resize the image according to the adjustment in 514, and may continue to 512.

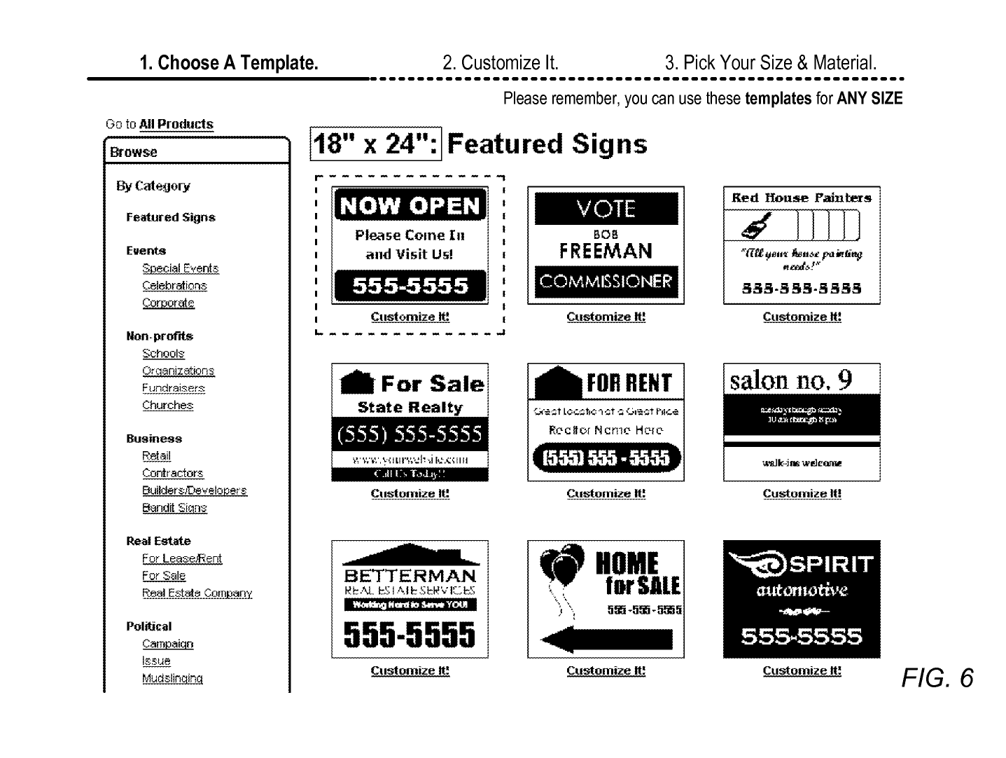

### FIGS. 6-13—Exemplary Walk Through

FIGS. 6-10 are exemplary screen shots of a walkthrough according to the methods described above. Note that these Figures are exemplary only and that other graphical interfaces, design layouts, user inputs, etc., are envisioned.

As shown in FIG. 6, the user may select a template sign. In this case, the user has selected an 18″×24″ sign which is a “Now Open” sign. As shown in FIG. 6, various other template signs are displayed for choice as well as categories on the left hand side. The categories may include types of sign (e.g., banners, yard signs, bumper stickers (e.g., events, non-profits, business, real estate, political, etc.) or, in one embodiment, sizes of signs, among other types of categories.

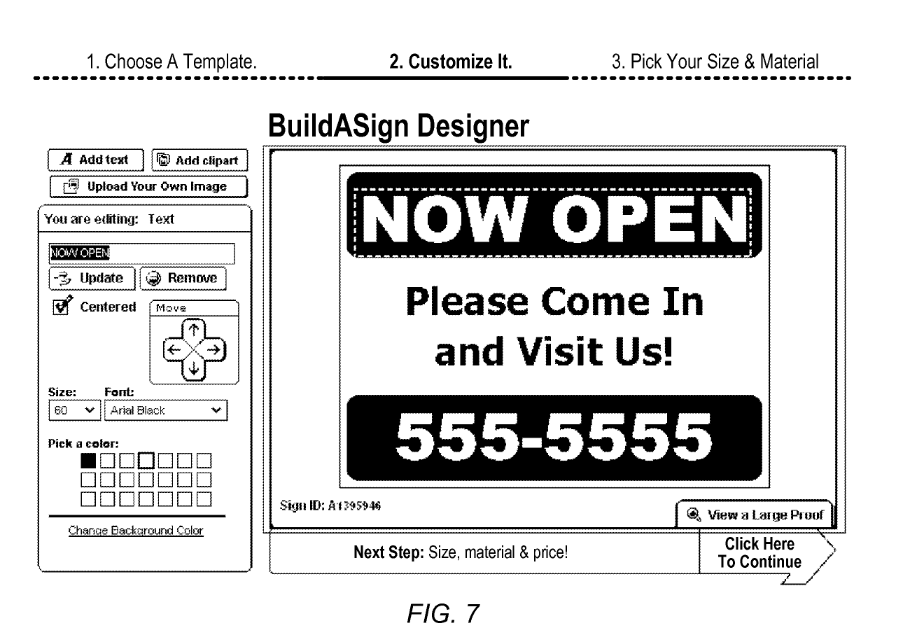

After selecting the “Now Open” sign from FIG. 6, FIG. 7 illustrates a designer GUI where the user can edit the design template. Thus, a representation of a sign is displayed on the display for the user to manipulate in order to design a sign. As shown, the user can select text (in this case, “Now Open”) and may perform various editing procedures, e.g., alignment, colors, font, font size, moving elements of the sign, adding text, adding clipart, uploading images, etc.

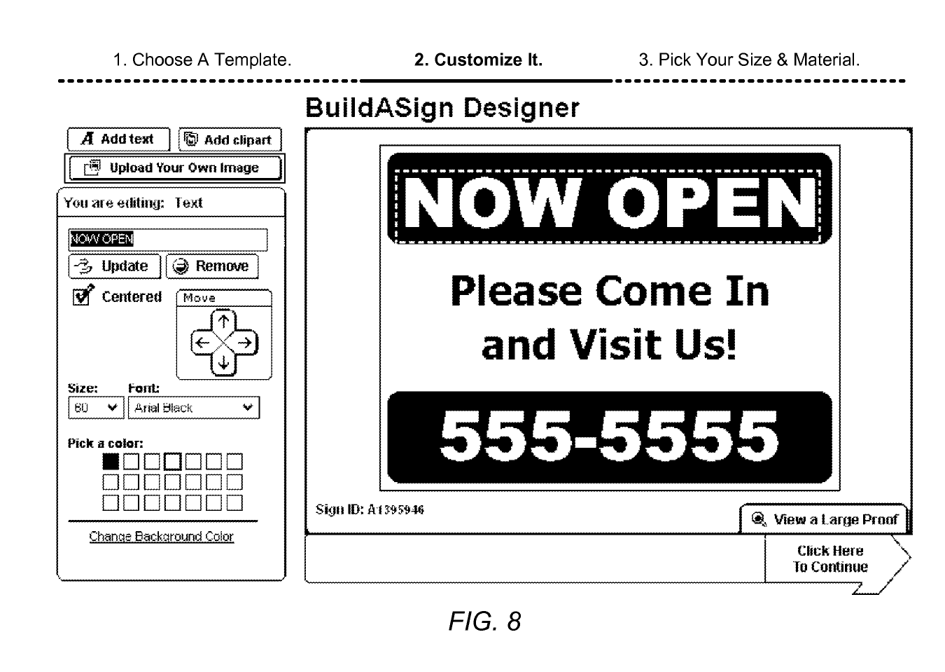

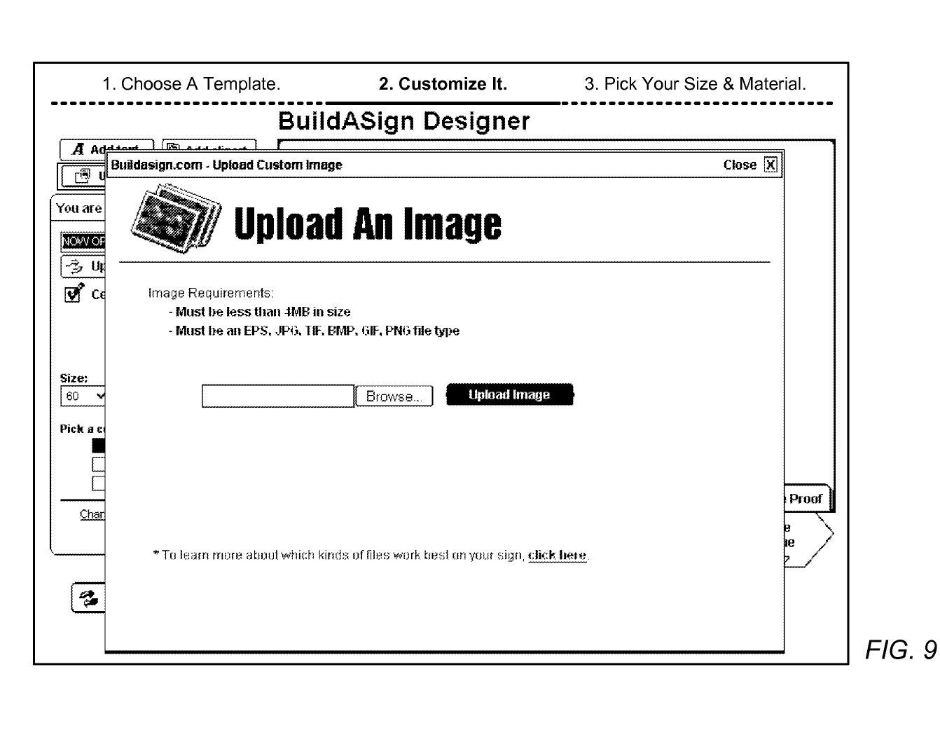

Turning now to FIG. 8, the user may select “Upload Your Own Image”. Correspondingly, in FIG. 9, the user may be presented with a dialog for selecting an uploading an image for incorporation into the design.

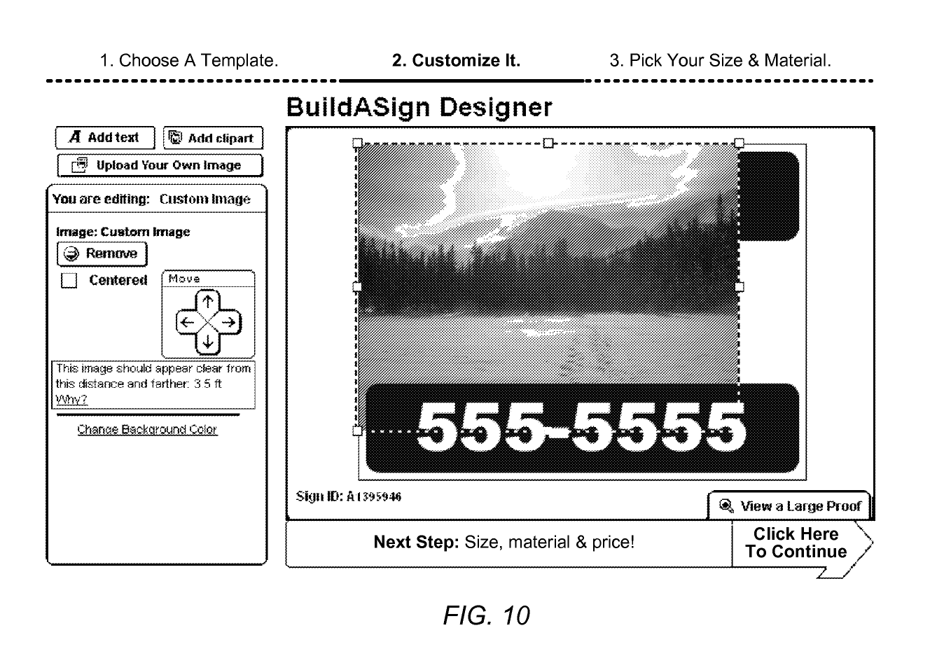

In response, the image may be displayed and selected in the design in FIG. 10. As shown, the left panel states that “This image should appear clear from this distance and farther: 3.5′”. Thus, the user is provided the image on the design at an initial printing size (e.g., as described above in FIG. 2).

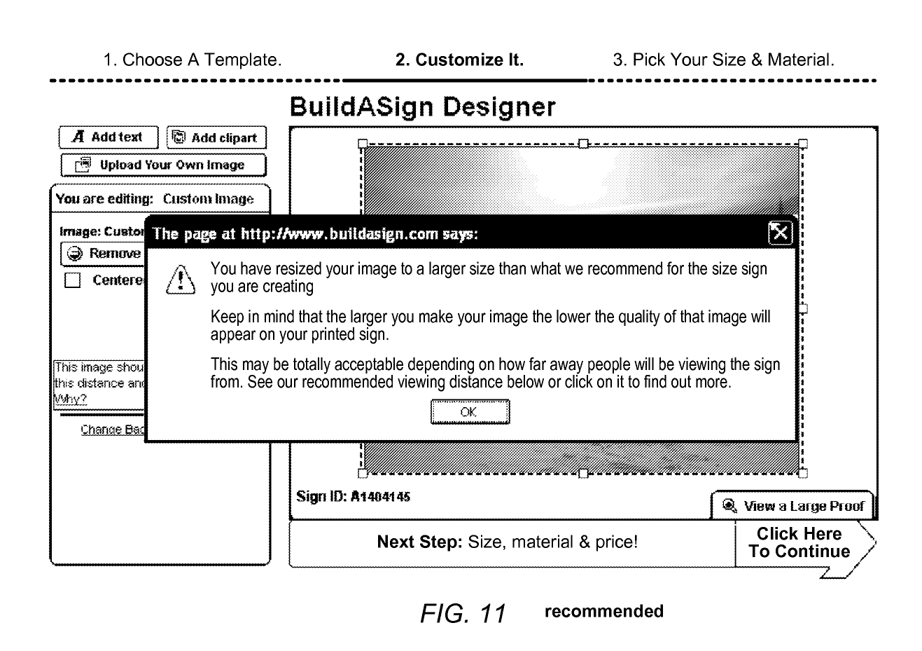

In FIG. 11, the user has resized the image to a size larger than the initial printing size. As shown, an error message is displayed. The error message states:

“You have resized your image to a larger size than what we recommend for the size sign you are creating. Keep in mind that the larger you make your image the lower the quality of that image will appear on your printed sign. This may be totally acceptable depending on how far away people will be viewing the sign from. See our recommended viewing distance below or click on it to find out more.”

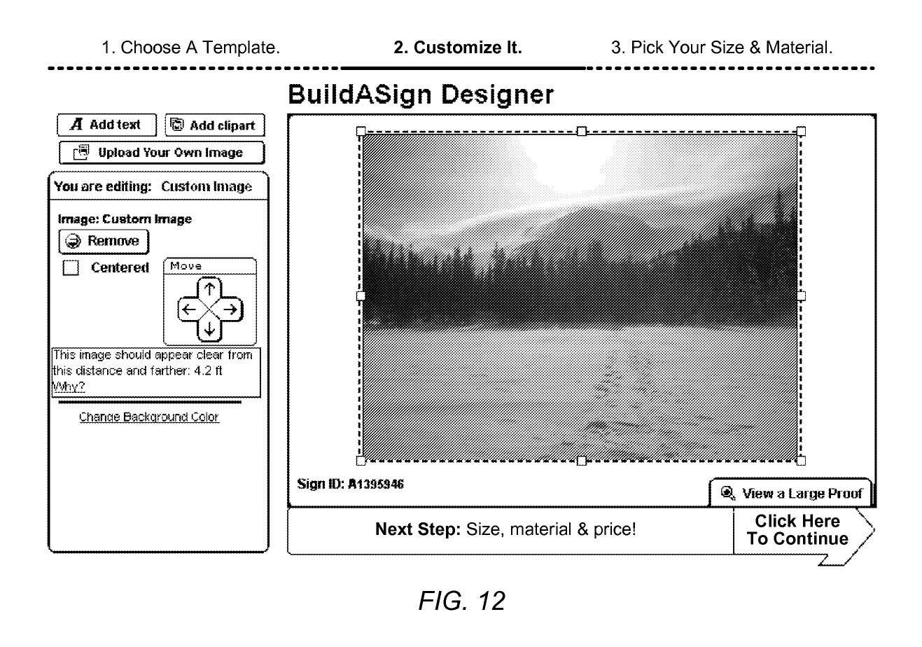

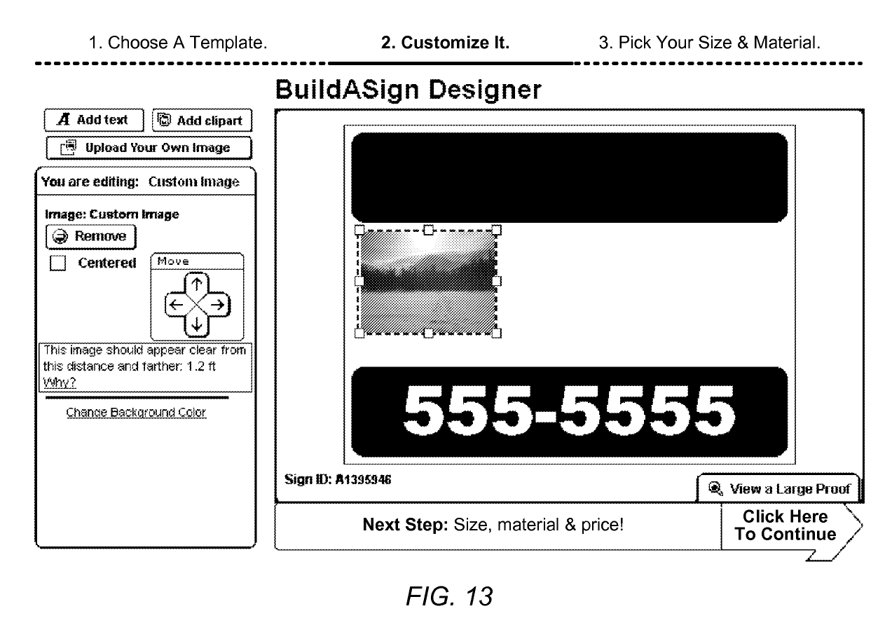

In FIG. 12, the image is displayed on the sign representation at the new printing size, and the minimum viewing distance is updated to 4.2 feet. In FIG. 13, the user has resized the image to a much smaller printing size, and the minimum viewing distance is changed to 1.2 feet.

Thus, FIGS. 6-13 provide an exemplary walk through according to a specific embodiment of the methods described herein.

Note that while embodiments of the present invention are described regarding signs, similar techniques apply to many other industries. More specifically, embodiments of the present invention may relate to any process involving determining and providing viewing distance information for images or text (or objects including images or text) which are manifested on a medium (e.g., printed on a physical medium). For example, the methods described above may also apply to various other objects which can be printed, e.g., t-shirts, cups, mugs, Frisbees, pens, and/or other consumer goods. Additionally, providing viewing distance information may relate to electronic signs, electronic displays, electronic paper, etc. Thus, determining viewing distance information may also relate to programmable or digital displays as well as physical signs. Furthermore, note that the determinations and methods described above may also apply to moving images or videos as well as static images/text. Thus, the particular implementations and descriptions regarding signs are exemplary only, and other embodiments are envisioned.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for providing viewing distance information to a user, comprising:
receiving an image;
analyzing the image to determine image quality properties of the image;
receiving user input specifying a printing size of the image;
determining viewing distance information of the image when presented at the printing size based on the image quality properties of the image and the printing size of the image; and
displaying the viewing distance information on a display.

2. The method of claim 1,
wherein said receiving user input specifying a printing size of the image, said determining viewing distance information, and said displaying are performed one or more additional times in an iterative manner.

3. The method of claim 1, further comprising:
creating a sign which includes the image, wherein the image has the printing size.

4. The method of claim 1, further comprising:
displaying a representation of a sign on a display, wherein the representation of the sign comprises a representation of the image at the printing size relative to the size of the sign, wherein said displaying the representation of the sign is performed after said receiving user input specifying the printing size of the image.

5. The method of claim 4, wherein said receiving user input specifying a printing size of the image comprises:
receiving user input specifying physical dimensions of the sign; and
receiving user input specifying a size of the representation of the image on the representation of the sign.

6. The method of claim 1, wherein the viewing distance information comprises a minimum viewing distance.

7. The method of claim 1, wherein the viewing distance information comprises a maximum viewing distance.

8. The method of claim 1, wherein the viewing distance information comprises an optimum viewing distance range.

9. The method of claim 1, said determining the viewing distance information comprises:
utilizing a predetermined product of viewing distance and image quality as a metric.

10. The method of claim 9, wherein the predetermined metric comprises a product of approximately 3.5 feet and approximately 100 dots per inch (DPI).

11. The method of claim 1, further comprising:
displaying a warning if the viewing distance information indicates that the printing size will produce a sub-optimal sign.

12. The method of claim 1, further comprising:
performing one or more image enhancement operations to improve the image quality properties of the image; and
performing said determining and said displaying based on said performing the one or more image enhancement operations.

13. The method of claim 1, further comprising:
converting at least a portion of the image to a vector format.

14. The method of claim 1, further comprising:
suggesting a different sign size based on said determining the viewing distance information.

15. The method of claim 1, further comprising:
prior to said receiving user input specifying a printing size of the image;
receiving user input selecting a size of the sign to be created;
automatically determining an initial printing size of the image based on the size of the sign, the image quality properties of the image, and a predetermined viewing distance metric;
wherein said receiving user input specifying a printing size of the image comprises user input adjusting the initial printing size of the image.

16. The method of claim 1, wherein said receiving the image is performed over a network.

17. A method for providing viewing distance information to a user, comprising:
receiving an image over a network;
receiving user input selecting a size of the sign to be created;
analyzing the image to determine image quality properties of the image;
automatically determining a printing size of the image based on the size of the sign, the image quality properties of the image, and a viewing distance metric;
displaying a representation of the sign on a display, wherein the representation of the sign comprises a representation of the image at the printing size.

18. The method of claim 17, further comprising:
creating a sign which includes the image, wherein the image has the final image size.

19. The method of claim 17, further comprising:
receiving user input specifying a new printing size of the image;
determining viewing distance information of the image when presented at the printing sized based on the image quality properties of the image and the new printing size of the image; and
displaying the viewing distance information on a display.

20. A memory medium comprising program instructions for specifying a sign based on user input, wherein the program instructions are executable to implement:
receiving user input specifying a size of the sign to be created;
receiving an image over a network;
analyzing the image to determine image quality properties of the image;
automatically determining an initial printing size of the image based on the size of the sign, the image quality properties of the image, and a viewing distance metric;
receiving user input adjusting the initial printing size of the image, wherein said adjusting produces a new printing size;
determining viewing distance information of the image when presented at the new printing size based on the image quality properties of the image and the new printing size of the image; and
displaying the viewing distance information on a display.
wherein the viewing distance information is useable by the user to interactively adjust the printing size of the image.

21. A method for designing a sign, comprising:
receiving an image over a network;
receiving user input specifying a size of a sign to be created;
receiving user input specifying a viewing distance for the sign, wherein the sign comprises the image;
analyzing the image to determine image quality properties of the image;
automatically determining a printing size of the image based on the size of the sign, the image quality properties of the image, the viewing distance for the sign, and a viewing distance metric;
displaying a representation of the sign on a display, wherein the representation of the sign comprises a representation of the image at the printing size relative to the size of the sign.

22. The method of claim 21, further comprising:
creating a sign which includes the image, wherein the image has the printing size.

23. The method of claim 21, further comprising:
performing one or more image enhancement operations on the image based on the viewing distance information and the image quality properties of the image.

24. The method of claim 21, further comprising:
resizing the sign based on the viewing distance and the image quality properties of the image.

25. The method of claim 21, further comprising:
providing one or more options for enabling viewability of the sign based on the image quality properties.

26. The method of claim 21, wherein the viewing distance comprises a minimum viewing distance and/or a maximum viewing distance.

27. A memory medium comprising program instructions for providing viewing distance information of a sign to a user, wherein the program instructions are executable to:
receive user input over a network, wherein the user input specifies the sign;
determine viewing distance information of the sign based on the user input; and
display the viewing distance information on a display, wherein the viewing distance information is usable by a user to fully specify the sign; and
create the sign.

28. The memory medium of claim 27,
wherein the user input specifies an image to be printed on the sign, and wherein the user input specifies a printing size of the image; and
wherein said determining the viewing distance information comprises:
analyzing the image to determine image quality properties of the image; and
determining image viewing distance information for the image when presented at the printing size based on the image quality properties of the image and the printing size of the image.

29. The memory medium of claim 27,
wherein the user input specifies text to be printed on the sign, and wherein the user input specifies a printing size of the text; and
wherein said determining the viewing distance information comprises determining text viewing distance information for the text when presented at the printing size based on the printing size of the text.
